(19) United States
(12) Patent Application Publication
(10) Pub. No.: US 2011/0061070 A1
(43) Pub. Date: Mar. 10, 2011

(54) PARTICIPANT TERMINAL DEVICE, WIRED AND WIRELESS COUPLED SERVER FOR SUPPORTING BROADCASTING PARTICIPATION, AND METHOD OF PROVIDING PARTICIPATIONAL BROADCASTING SERVICE

(75) Inventors: Seung-Hun OH, Gwangju (KR); Sim-Kwon YOON, Gwangju (KR); Byung-Tak LEE, Suwon-si (KR); Jai Sang KOH, Gwangju (KR)

(73) Assignee: Electronics and Telecommunications Research Institute, Daejeon (KR)

(21) Appl. No.: 12/875,812

(22) Filed: Sep. 3, 2010

(30) Foreign Application Priority Data
Sep. 4, 2009 (KR) 10-2009-0083573
Jul. 30, 2010 (KR) 10-2010-0073918

(51) Int. Cl. H04N 7/16

(52) U.S. Cl. 725/25

(57) ABSTRACT

Provided are a participant terminal device, a wired and wireless coupled server for supporting broadcasting participation, and a method of providing a participational broadcasting service. The wired and wireless coupled server may include: an information obtainment unit to obtain channel information associated with a broadcast provided to at least one participant terminal device among a plurality of terminal devices in response to a participation request from the at least one participant terminal device; and an information processor to enable the at least one participant terminal device to access a participation control server associated with the broadcasting participation using participation address information corresponding to the obtained channel information by identifying the participation address information and transmitting the identified participation address information to the at least one participant terminal device.

### CROSS-REFERENCE TO RELATED APPLICATION

This application claims the benefit of Korean Patent Application No. 10-2009-0083573, filed on Sep. 4, 2009 and Korean Patent Application No. 10-2010-0073918 filed on Jul. 30, 2010 in the Korean Intellectual Property Office, the disclosure of which is incorporated herein by reference.

### BACKGROUND

1. Field of the Invention

Embodiments of the present invention relate to a participational broadcasting apparatus for readily supporting broadcasting participation using various types of participant terminal devices, a wired and wireless coupled server for supporting the broadcasting participation, and a method of providing a participational broadcasting service.

2. Description of the Related Art

A participational broadcasting indicates a type of a broadcasting that may induce viewers' participation by inserting, into broadcasting data, voice, images, and the like received from the viewers during a broadcast and thereby broadcasting the broadcasting data. Currently, an Internet Protocol Television (IPTV) broadcasting scheme is proposed where an IP Multimedia Subsystem (IPMS)-based control system controls general operations for viewers' image insertion and a participational broadcasting system, and manages the viewers' participation.

However, a transfer of a participational broadcasting content may consider only an IP network and a device participating in the broadcasting is limited to a PC. Specifically, a broadcasting participation system using various types of terminals is not proposed. Accordingly, there is a desire for a participant terminal device for accessing a desired channel when a plurality of broadcasting programs providing a participational broadcasting function exists, and a method of providing a participational broadcasting service.

### SUMMARY

An aspect of the present invention provides a participant terminal device that may access a participation control server using one of predetermined participation address information, participation address information received from a wired and wireless coupled server, participation address information obtained using channel information, and participation address information provided using a broadcasting image, and thereby may readily perform broadcasting participation, and a method of providing a participational broadcasting service.

Another aspect of the present invention also provides a wired and wireless coupled server that may perform a smooth communication among a participation control server, a media mixer server, and a participant terminal joining a communication provider (hereinafter, “participant terminal device”), and may provide, to the participant terminal device according to a participation request, mixed broadcasting data in which participation data is mixed, by understanding different control signals and converting the control signals to a predetermined control standard when a communication is performed between the participation control server and the participant terminal device, and a method of providing a participational broadcasting service.

According to an aspect of the present invention, there is provided a wired and wireless coupled server for supporting broadcasting participation, including: an information obtainment unit to obtain channel information associated with a broadcast provided to at least one participant terminal device among a plurality of terminal devices in response to a participation request from the at least one participant terminal device; and an information processor to enable the at least one participant terminal device to access a participation control server associated with the broadcasting participation using participation address information corresponding to the obtained channel information by identifying the participation address information and transmitting the identified participation address information to the at least one participant terminal device.

According to another aspect of the present invention, there is provided a participant terminal device for supporting broadcasting participation, including: a user command receiver to receive a participation request of a user for a provided broadcasting; a broadcasting participation controller to generate a request message in response to the participation request, to transmit the request message to a participation control server identified by participation address information, and to receive a response message from the participation control server; and a media processor to transmit, to a media mixer server using a media session established according to reception of the response message, participation data input by the user.

According to still another aspect of the present invention, there is provided a wired and wireless coupled server for supporting broadcasting participation, including: a media conversion controller to adjust, based on a media standard, participation address information for participation into a broadcast provided to a participant terminal device, and to control a media mixer server to match the participation address information with broadcasting data; and a channel association manager to provide the matched broadcasting data to the participant terminal device, and to provide an interface for an input of participation data to the participant terminal device when the participant terminal device requests a participation using the participation address information.

### EFFECT

According to embodiments of the present invention, it is possible to readily perform broadcasting participation by accessing a participation control server using one of predetermined participation address information, participation address information received from a wired and wireless coupled server, participation address information obtained using channel information, and participation address information provided using a broadcasting image.

Also, according to embodiments of the present invention, there may be provided a participant terminal device that may perform a smooth communication among a participation control server, a media mixer server, and a participant terminal joining a communication provider, and may provide, to the participant terminal device according to a participation request, mixed broadcasting data in which participation data is mixed, by understanding different control signals and converting the control signals to a predetermined control standard when a communication is performed between the participation control server and the participant terminal device.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a participational broadcasting model including a wired and wireless coupled server according to an embodiment of the present invention;

FIG. 2 is a diagram illustrating a configuration of a wired and wireless coupled server for supporting broadcasting participation according to an embodiment of the present invention;

FIG. 3 through FIG. 6 illustrate examples of obtaining broadcasting information associated with broadcasting data according to an embodiment of the present invention;

FIG. 7 is a diagram illustrating a configuration of a participant terminal device according to an embodiment of the present invention;

FIG. 8 is a diagram illustrating a configuration of a wired and wireless coupled server according to another embodiment of the present invention; and

FIG. 9 is a flowchart illustrating an operation method of a participant terminal device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The term “participant terminal device” used throughout the present specification may indicate a user's mobile terminal that may receive a broadcast provided from a broadcasting server and receive participation data created by the user to thereby match the participation data with the broadcasting using a media mixer server and to broadcast the participation data over a broadcasting network.

Also, the term “participation address information” indicates information to identify a participation control server, and may include, for example, a telephone number using a number system, a Universal Resource Identification (URI) such as an e-mail, and the like. Here, the participation control server may transfer, to the media mixer server, the participation data input from the participant terminal device to thereby mix the participation data with a broadcasting signal using the media mixer server and then provide the mixed participation data over the broadcasting network.

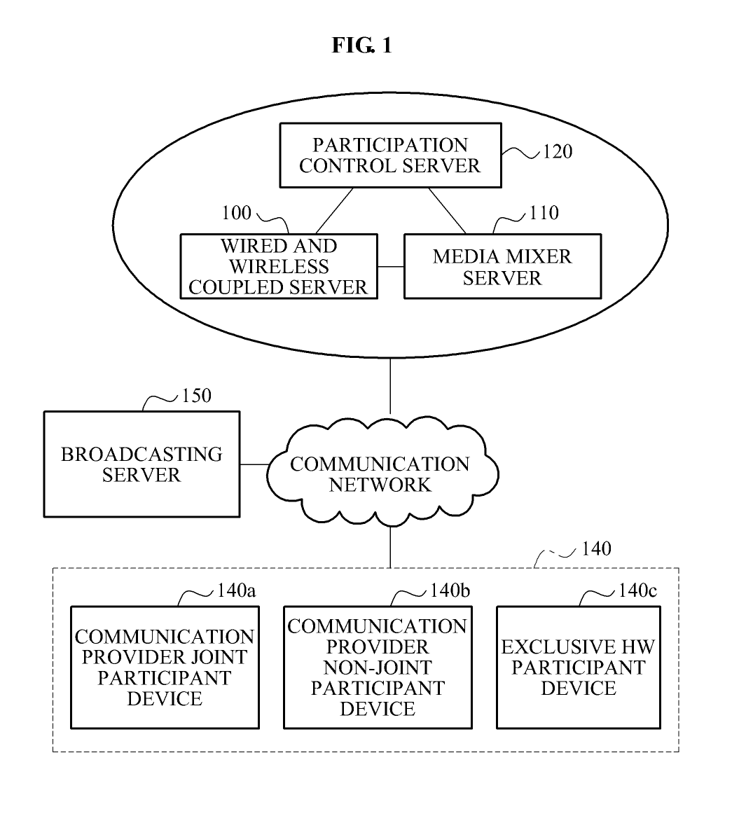

FIG. 1 is a diagram illustrating a configuration of a participational broadcasting model including a wired and wireless coupled server 100 according to an embodiment of the present invention.

As shown in FIG. 1, the participational broadcasting model may include the wired and wireless coupled server 100, a media mixer server 110, and a participation control server 120. The wired and wireless coupled server 100 may access a participant terminal device 140 provided in various types. The media mixer server 110 may mix participation data received from the participant terminal device 140 with broadcasting data provided from a broadcasting server 150. The participation control server 120 may establish a session according to a predetermined condition with the participant terminal device 140 having generated a participation request for broadcasting, and may receive the participation data from the participant terminal device 140 over the established session.

The broadcasting server 150 may transmit broadcasting data to the media mixer server 110 over a communication network, for example, a data communication network such as an Internet network, an Internet Protocol Television (IPTV) network, and the like.

The media mixer server 110 may receive the broadcasting data and transmit the received broadcasting data to the participant terminal device 140 over the communication network connected with the participant terminal device 140. The communication network may be, for example, a terrestrial broadcasting network, a satellite broadcasting network, a wireless data communication network, a broadcasting communication network such as a cable broadcasting network, and the like.

Depending on embodiments, in addition to the broadcasting data, the media mixer server 110 may transmit participation address information to the participant terminal device 140 as information to identify the participation control server 120.

When the participation data is received from the participant terminal device 140 via the participant control server 120, the media mixer server 110 may generate mixed broadcasting data by mixing the broadcasting data with the participation data, and transmit the generated mixed broadcasting data to the participant terminal device 140, thereby providing a participational broadcasting.

The participation control server 120 may perform a communication through a session establishment with the participant terminal device 140 making an access using the participation address information, may receive the participation data for broadcasting participation through the established session, and may transfer the received participation data to the media mixer server 110.

The wired and wireless coupled server 100 may control a communication among the media mixer 110, the participation control server 120, and the participant terminal device 140.

Specifically, the wired and wireless coupled server 100 may process a control signal between the participation control server 120 and the participant terminal device 140, may process participation data between the media mixer server 110 and the participant terminal device 140, and may induce the user to participate into the broadcasting using the participant terminal device 140.

The participant terminal device 140 may be one of a terrestrial broadcasting reception apparatus, a satellite broadcasting reception apparatus, a wireless broadcasting reception apparatus, and an IPTV reception apparatus. The participant terminal device 140 may display broadcasting data or mixed broadcasting data in which participation data is mixed, which are received from the media mixer server 110.

The participant terminal device 140 may be a mobile terminal held by a user and be provided in various types of forms. For example, the participant terminal device 140 may include a communication provider joint participant device 140a, a communication provider non joint participant device 140b, and an exclusive Hardware (HW) participant device 140c.

The communication provider joint participant device 140a that is one type of the participant terminal device 140 may indicate a terminal that joins a communication provider network and is assigned with a telephone URI. The communication provider non joint participant device 140b may indicate a terminal that does not join the communication provider network and thus, is unassigned with the telephone URI. Here, the communication provider joint participant device 140a and the communication provider non joint participant device 140b may be classified depending on whether a right to use an authorized service from the media mixer server 110 via the wired and wireless coupled server 100 is assigned. The communication provider non joint participant device 140b may also receive the broadcasting data by means of the broadcasting server 150.

The exclusive HW participant device 140c that is another type of the participant terminal device 140 may indicate a terminal, that is, a P-module that may be exclusively used for broadcasting participation. The exclusive HW participant device 140c may include a brief menu function for the broadcasting participation and the like, and may be designed to transmit desired participation data through a single menu selection.

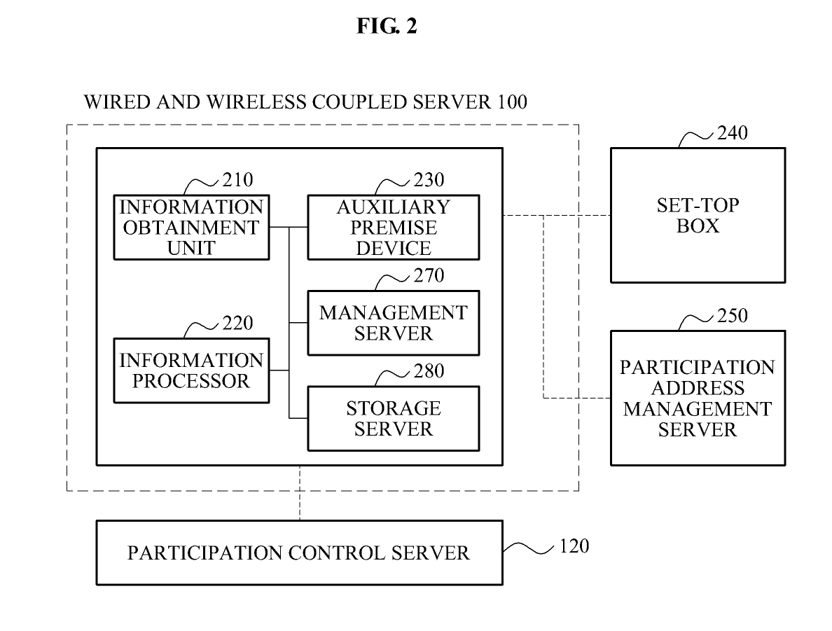

FIG. 2 is a diagram illustrating a configuration of a wired and wireless coupled server 100 for supporting broadcasting participation according to an embodiment of the present invention.

Regardless of whether the participant terminal device 140 held by a user is in a wired type or in a wireless type, the wired and wireless coupled server 100 may provide an optimal environment for each type. Therefore, the user may generate mixed broadcasting data by mixing broadcasting data about current broadcasting with participation data created by the user, and may transmit the generated mixed broadcasting data to a plurality of terminals over a broadcasting network.

The wired and wireless coupled server 100 may include an information obtainment unit 210 and an information processor 220.

In response to a participation request from at least one participant terminal device, for example, the participant terminal device 140 of FIG. 1 among the plurality of terminal devices, the information obtainment unit 210 may obtain channel information associated with the broadcast provided to the participant terminal device 140. Here, the participant terminal device 140 may be any type of terminal that includes the exclusive HW participant device 140c, and that has a function of receiving broadcasting data. Also, the participation request may occur according to a selection input on a menu displayed on a screen where the broadcasting data is displayed. The participation request may occur in the participant terminal device 140 and thereby be transmitted to the wired and wireless coupled server 100.

Specifically, when broadcasting participation is selected and thereby the participation request occurs in the participant terminal device 140 according to an intent of a user viewing the broadcasting using the participant terminal device 140, the information obtainment unit 210 may obtain information associated with the broadcast provided to the participant terminal device 140.

The channel information may be information defined in a form to easily identify a frequency band where the broadcasting data is transmitted. For example, when the broadcasting data is transmitted in the frequency band of 174 MHz through 180 MHz, the channel information may be defined as “channel 7”.

The channel information may be obtained to systematically identify the broadcasting data provided to the participant terminal device 140. When the participant terminal device 140 corresponds to the exclusive HW participant device 140c, a corresponding terminal may have a memory space for maintaining the channel information. The channel information may be retrieved from the memory space and thereby be obtained.

Hereinafter, an example of the information obtainment unit 210 obtaining channel information from an external broadcasting providing means when the participant terminal device 140 corresponds to a terminal having a general broadcasting receiving function and thus, does not store channel information will be described.

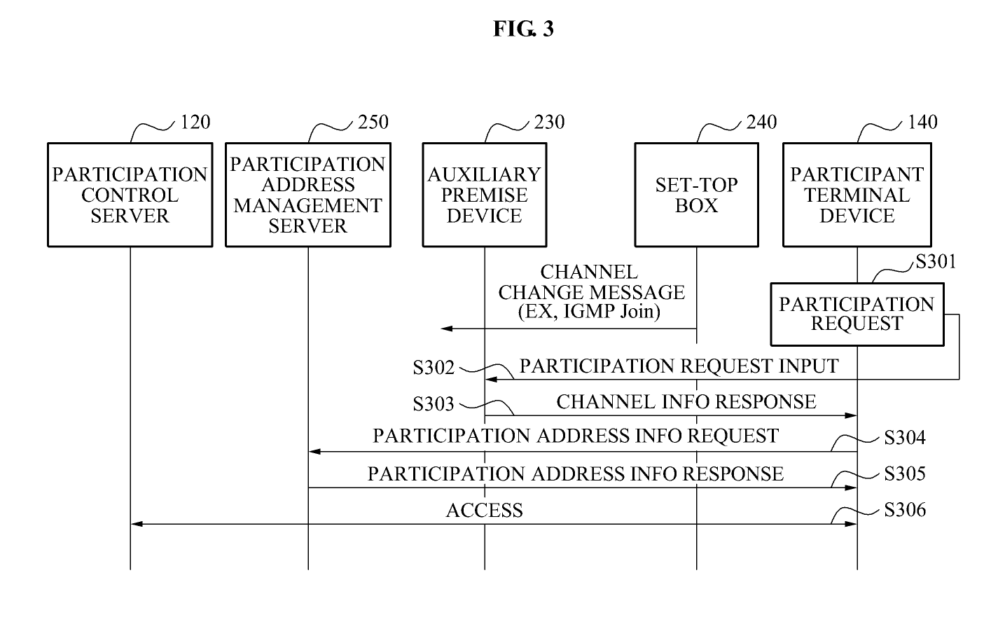

FIG. 3 through FIG. 6 illustrate examples of obtaining broadcasting information associated with broadcasting data according to an embodiment of the present invention.

FIG. 3 illustrates an example of obtaining channel information using an auxiliary premise device 230 according to an embodiment of the present invention.

The auxiliary premise device 230 may have a function of caching a channel change message transmitted from a set-top box 240 providing a broadcast to the participant terminal device 140. For example, the auxiliary premise device 230 may be configured as a wireless sharer, an access point (AP), a modem, and the like.

The channel change message may include information associated with a change in broadcasting data provided from the set-top box 240 to the participant terminal device 140. For example, the channel change message may correspond to information that is generated by the set-top box 240 due to a channel change made according to a channel change request of a user and thereby is transmitted to a predetermined equipment, for example, a statistics server for a rating survey.

The information obtainment unit 210 of the wired and wireless coupled server 100 may analyze the cached channel change message to obtain channel information regarding a channel being currently viewed in the participant terminal device 140.

Referring to FIG. 3, the auxiliary premise device 230 may cache the channel change message periodically or in real time using Internet Group Management Protocol (IGMP) snooping and the like.

When a participation request occurs in the participant terminal device 140 in operation S301, the auxiliary premise device 230 may receive the participation request in operation S302, and may cache a channel change message in response to the participation request. Next, the information obtainment unit 210 may obtain channel information from the cached channel change message.

In operation S303, the obtained channel information may be transmitted to the participant terminal device 140 by means of the auxiliary premise device 230. The participant terminal device 140 may recognize broadcasting data, that is, a channel currently provided to the participant terminal device 140.

In operation S304, the participant terminal device 140 may request a participation address management server 250 for participation address information stored in correspondence to the channel information, using the channel information. Here, the participation address management server 250 may manage participation address information. The participant terminal device 140 may request the participation address management server 250 for participation address information as information for identifying the participation control server 120 of controlling the user's participation into the broadcasting.

The participation address management server 250 may manage the participation address information in correspondence to the channel information. For example, the participation address management server 250 may store participation address information ‘ch7 seoul@join_broadcast.com’ in correspondence to channel information “ch 7”.

In response to the participation address information request, the participation address management server 250 may transmit, to the participant terminal device 140, participation address information corresponding to the channel information in operation S305. In operation S306, the participant terminal device 140 receiving the participation address information may access the participation control server 120 identified by the participation address information, and receive a participational broadcasting service according to a control of the participation control server 120.

The information obtainment unit 210 may transmit an information transmission command to the set-top box 240 in interoperation with the participation request. As a response to the information transmission command, the information obtainment unit 210 may receive, from the set-top box 240, channel information associated with a broadcasting being provided to the participant terminal device 140.

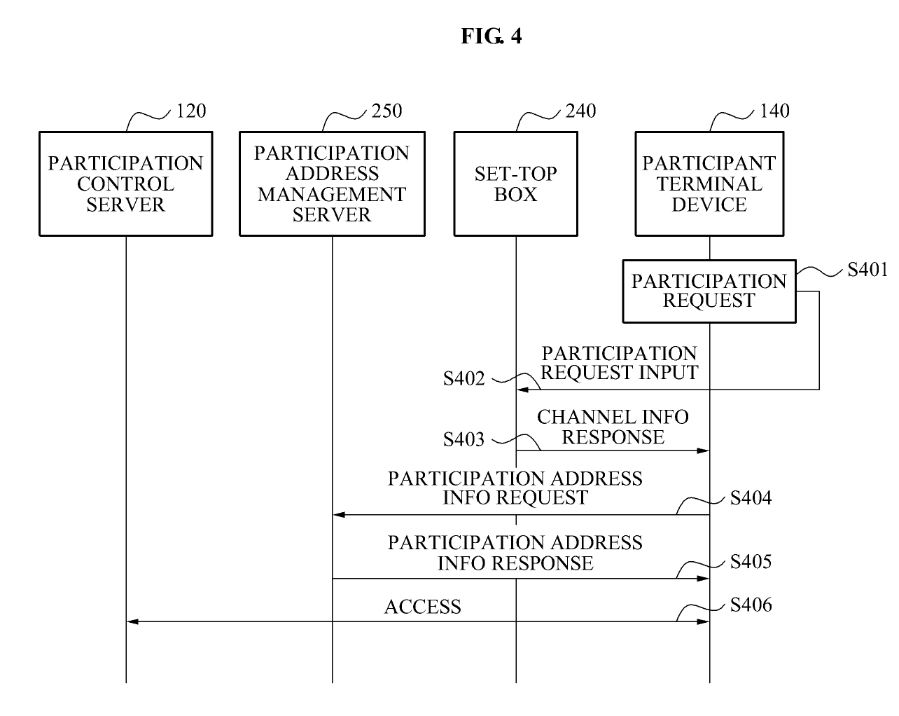

Referring to FIG. 4, when a participation request occurs in the participant terminal device 140 in operation S401, the set-top box 240 may receive the participation request in operation S402. The information obtainment unit 210 may transmit the information transmission command to the set-top box 240, so that channel information associated with broadcasting data currently provided to the participant terminal device 140 may be provided from the set-top box 240 to the participant terminal device 140 in operation S403.

When the participant terminal device 140 requests the participation address management server 250 for participation address information using the channel information in operation S404, the participant terminal device 140 may receive the participation address information from the participation address management server 250 in operation S405.

In operation S406, the participant terminal device 140 may access the participation control server 120 by transmitting a request message for broadcasting participation to the participation control server 120 using the received participation address information.

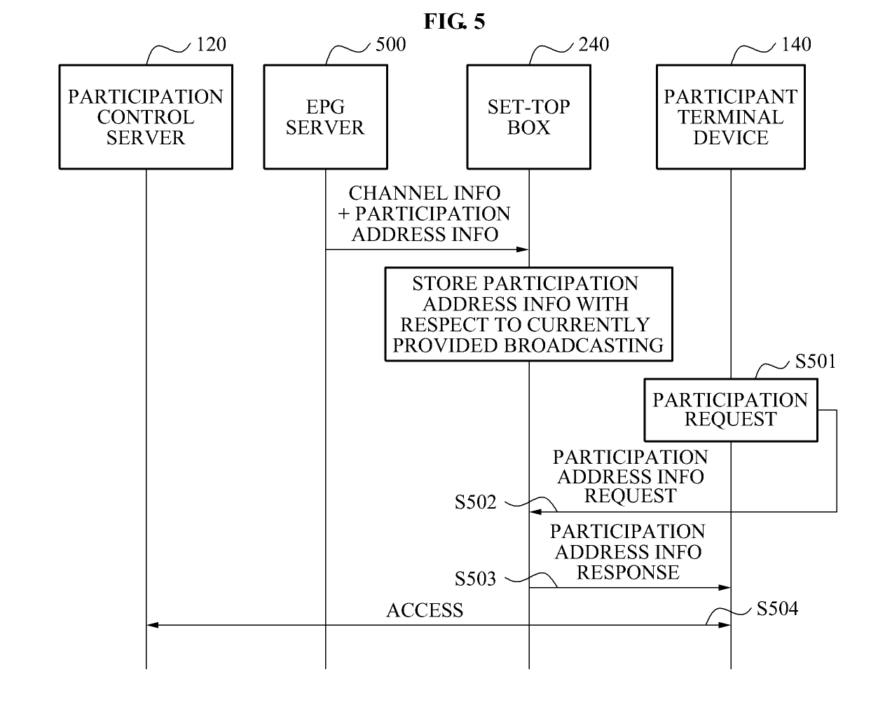

Referring to FIG. 5, the participant terminal device 140 may request the set-top box 240 for participation address information in operations S501 and S502, and may receive the participation address information from the set-top box 240 in response to the request in operation S503.

In this instance, the information obtainment unit 210 may obtain channel information from an EPG providing guidance with respect to a broadcast or broadcasting data to be provided to the participant terminal device 140.

When the set-top box 240 requests an EGP server 500 for the channel information, the EPG server 500 may transmit the channel information and the participation address information to the set-top box 240. The set-top box 240 may store the channel information and the participation address information based on the broadcasting being currently provided to the participant terminal device 140.

Specifically, in response to the participation request from the participant terminal device 140, the information obtainment unit 210 may provide stored participation address information to the participant terminal device 140.

In operation S504, the participant terminal device 140 may access the participation control server 120 through a session establishment, and may transmit a request message for broadcasting participation to the participation control server 120.

As another example of obtaining participation address information, the wired and wireless coupled server 100 may verify the set-top box 240 of providing broadcasting data to the participant terminal device 140, and may obtain, from the verified set-top box 240, information associated with a broadcasting being currently provided to the participant terminal device 140, for example, channel information.

For the above operation, the wired and wireless coupled server 100 may include a management server 270 to register the set-top box 240 assigned to the participant terminal device 140 and a storage server 280 to store channel information associated with a broadcasting being provided to the participant terminal device 140 by means of the assigned set-top box 240.

The management server 270 may maintain information associated with the assigned set-top box 240 for providing broadcasting data for each participant terminal device. The storage server 280 may share and store information associated with the broadcasting data being currently provided from the set-top box 240 to the participant terminal device 140.

The information obtainment unit 210 may verify, from the management server 270, the set-top box 240 assigned to the participant terminal device 140 having generated the participation request, and may receive the maintaining channel information from the storage server 280 sharing the channel information of the verified set-top box 240. Specifically, the information obtainment unit 210 may verify, from the management server 270 registering set-top boxes assigned to a plurality of terminal devices, the set-top box 240 assigned to the participant terminal device 140, and may receive the channel information from the verified set-top box 240.

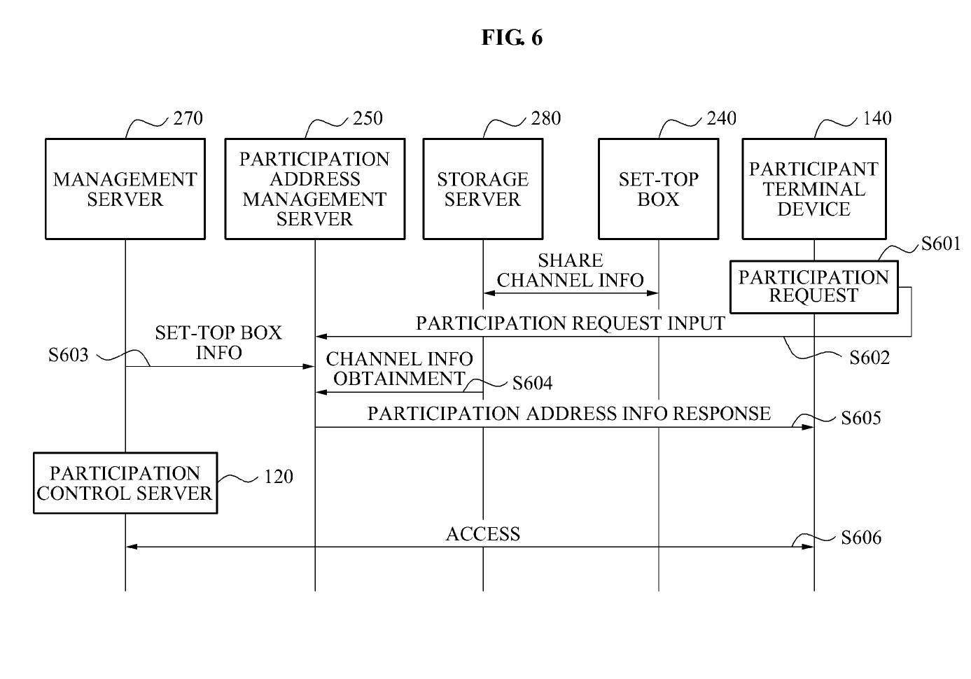

Referring to FIG. 6, when a participation request occurs in the participant terminal device 140 in operation S601, the participation address management server 250 may input the participation request in operation S602.

In operation S603, according to a control of the information obtainment unit 210, the participation address management server 250 may receive, from the management server 270, information associated with the set-top box 240 assigned to the participant terminal device 140 having generated the participation request. In operation S604, the participation address management server 250 may access the set-top box 240 or the storage server 280 sharing the channel information of the corresponding set-top box 240 using the received information to thereby obtain the channel information.

Specifically, the participation address management server 250 may receive set-top box information from the management server 270, and may receive channel information of the set-top box 240 from the set-top box 240 or the storage server 280 using the set-top box information.

In operation S605, the participation address management server 250 may retrieve participation address information corresponding to the received channel information by referring to, for example, a participation address mapping list maintained in advance, and may transmit the retrieved participation address information to the participant terminal device 140.

In operation S606, the participant terminal device 140 may access the participation control server 120 using the participation address information, and may transmit a request message for broadcasting participation to the participation control server 120.

Referring again to FIG. 2, the information processor 220 included in the wired and wireless coupled server 100 may identify participation address information corresponding to channel information that may be obtained using various types of schemes, and may transmit the identified participation address information to the participant terminal device 140. As described above with reference to FIG. 3 through FIG. 6, the information processor 220 may retrieve and identify participation address information corresponding to channel information from the participation address management server 250.

The participant terminal device 140 may establish a session with the participation control server 120 associated with broadcasting participation using the received participation address information, and thereby access the participation control server 120.

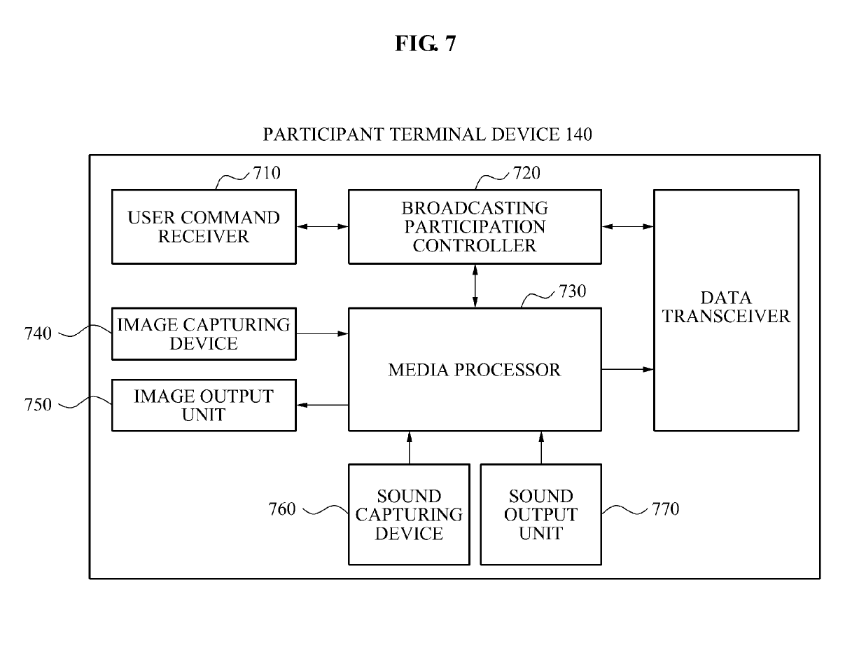

FIG. 7 is a diagram illustrating a configuration of a participant terminal device 140 according to an embodiment of the present invention.

The participant terminal device 140 may include a user command receiver 710, a broadcasting participation controller 720, and a media processor 730.

Referring to FIG. 7, the user command receiver may receive a user's participation request for a provided broadcasting. Specifically, the user command receiver 710 may be provided in a key button type in the participant terminal device 140, or may be provided on a screen in a menu form to thereby generate a participation request according to the user's selection input.

According to the participation request, the broadcasting participation controller 720 may generate a request message and transmit the request message to the participation control server 120 identified based on participation address information. The broadcasting participation controller 720 may receive a response message from the participation control server 120 receiving the request message, and thereby establish a media session between the participant terminal device 140 and the participation control server 120.

Through the media session, the media processor 730 may transmit, to the media mixer server 110, participation data input by the user. The participation data may be broadcasting data for broadcasting participation, generated by the user. For example, the participation data may be private broadcasting data generated using an image camera installed at home, a video phone, a Universal Serial Bus (USB) camera, and the like.

According to another embodiment of the present invention, the participant terminal device 140 may further include an image capturing device 740, an image output unit 750, a sound capturing device 760, and a sound output unit 770.

In association with providing of an image at the participant terminal device 140, the image capturing device 740 may receive, from a user, image data as participation data. The image output unit 750 may receive and display mixed broadcasting data in which the image data is mixed.

In association with providing of a sound at the participant terminal device 140, the sound capturing device 760 may receive, from the user, sound data as the participation data. The sound output unit 770 may receive, from the media mixer server 110, mixed broadcasting data in which the sound data is mixed, and output the mixed broadcasting data.

Referring to FIG. 7, in a state where broadcasting data passing through the media mixer server 110 is provided to the participant terminal device 140 based on the channel information, the user command receiver 710 may generate the request message according to the user's participation request, and may transmit the generated request message to the participation control server 120 over a wired and wireless communication network. Here, the user command receiver 710 may transmit the request message to the participation control server 120.

As described above, the channel information may be access information to view a corresponding broadcasting and thus, be a URI. When a broadcasting environment is an IPTV network, the channel information may indicate a multicast address or a port number. When the broadcasting environment is a terrestrial broadcasting network, a cable broadcasting network, a satellite broadcasting network, or a Digital Multimedia Broadcasting (DMB) network, the channel information may indicate a frequency band.

The participation address information may be information to participate into a viewing broadcasting, that is, information capable of identifying the participation control server 120, for example, a control URI.

Also, the broadcasting participation controller 720 may transmit a request message to the participation control server 120 using internally stored predetermined participation address information. In this case, the participant terminal device 140 may be a terminal, for example, a P-module that may be exclusively used for broadcasting participation.

Also, the broadcasting participation controller 720 may transmit the request message to the participation control server 120 using participation address information received from the wired and wireless coupled server 100.

The user command receiver 710 may receive channel information from one of the auxiliary premise device 230, the set-top box 240, and the storage server 280, and may obtain, from the wired and wireless coupled server 100 or the EPG server 500 using the received channel information, participation address information corresponding to the channel information.

The media processor 730 may include the image capturing device 740 and the image output unit 750, or the sound capturing device 760 and the sound output unit 770, and may receive, from the media mixer server 100, mixed broadcasting data in which participation data is mixed, and display or output the mixed broadcasting data. Here, the mixed broadcasting data indicates mixed data in which the broadcasting data and the participation data are mixed.

The broadcasting participation controller 720 may receive the user command using the user command receiver 710 to generate the request message about broadcasting participation, and may receive and process a response message from the participation control server 120 receiving the request message and may control the media processor 730 so that the user may participate into the broadcasting.

When the participant terminal device 140 corresponds to the communication provider joint participant device 140a, the participant terminal device 140 may participate into the broadcasting through communication with the participant control server 120 and the media mixer server 110 via the wired and wireless coupled server 100.

Specifically, according to the user's participation request using the participation address information, the user command receiver 710 may generate the request message and transmit the request message to the participation control server 120 identified based on the participation address information via the wired and wireless coupled server 100. Here, the participation address information may be mixed in a subtitle form together with a participational broadcasting in the media mixer server 110, and thereby be provided on the broadcasting screen.

When a response message to the request message is received from the participation control server 120 via the wired and wireless coupled server 100, the media processor 730 may transmit participation data input by the user to the media mixer server 110 via the wired and wireless coupled server 100, may receive, from the media mixer server 110 via the wired and wireless coupled server 100, and thereby display mixed broadcasting data in which the participation data is mixed.

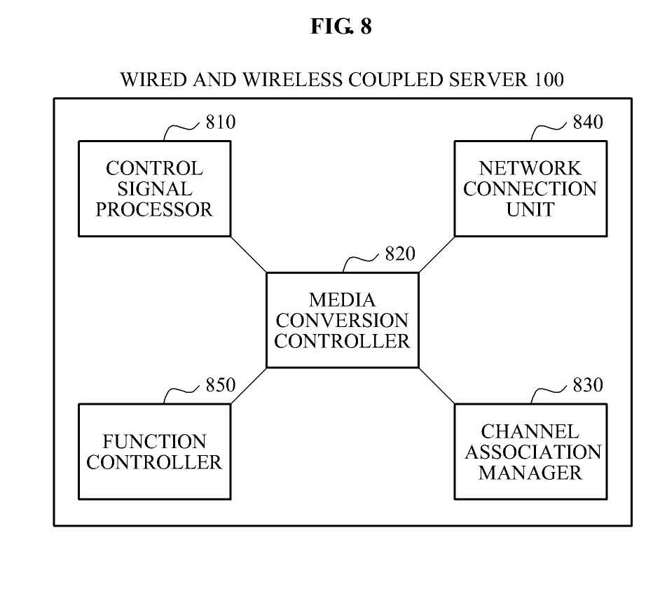

FIG. 8 is a diagram illustrating a configuration of a wired and wireless coupled server 100 according to another embodiment of the present invention.

Hereinafter, the wired and wireless coupled server 100 of providing, to the participant terminal device 140, broadcasting data and number stream form information, for example, a telephone URI for accessing the participation control server 120, as participation address information, and providing a participational broadcasting service to the participant terminal device 140 establishing a media session with the participation control server 120 by inputting the alphanumeric form information will be described with reference to FIG. 8.

The wired and wireless coupled server 100 may include a control signal processor 810, a media conversion controller 820, and a channel association manager 830.

The control signal processor 810 may retrieve participation address information for participation into a broadcast provided to the participant terminal device 140. Specifically, the control signal processor 810 may retrieve the participation address information from a database (not shown) storing in advance alphanumeric form information, for example, a telephone URI for accessing the participation control server 120. As another example, without a separate search process through interoperation with a predetermined broadcasting server, the control signal processor 810 may immediately recognize participation address information of the broadcast provided to the participant terminal device 140.

The media conversion controller 820 may adjust the retrieved participation address information according to a media standard. The media conversion controller 820 may convert a format of the participation address information in a telephone URI so that the participation address information may be provided via the participant terminal device 140 during a broadcast.

Also, the media conversion controller 820 may control the media mixer server 110 to match the adjusted participation address information with broadcasting data. Through this, the participation address information for the broadcasting participation may be included in the broadcasting data provided to the participant terminal device 140.

When the broadcasting matched with the participation address information is provided to the participant terminal device 140, and when a participation request occurs using the participation address information in the participant terminal device 140, the channel association manager 830 may provide an interface for input of participation data to the participant terminal device 140. Specifically, the channel association manager 830 may provide the interface for inputting participation data for broadcasting participation to the participant terminal device 140 having established a media session with the participation control server 120 by employing a telephone URI as the participation address information.

A configuration of the wired and wireless coupled server 100 inducing the user's broadcasting participation by providing participation address information in a alphanumeric form during a broadcast will be further described with reference to FIG. 8.

As shown in FIG. 8, the wired and wireless coupled server 100 may further include a network connection unit 840 and a function controller 850 in addition to the control signal processor 810, the media conversion controller 820, and the channel association manager 830.

The network connection unit 840 corresponds to a means for supporting the participant terminal device 140. Therefore, according to a participation request from the participant terminal device 140 using participation address information, the network connection unit 840 may generate a request message to be suitable for a predetermined standard, for example, a participational broadcasting control standard, and may transmit the request message to the participation control server 120.

When the participation request of the participant terminal device 140 is accepted and thereby the media session with the participation control server 120 is established, the network connection unit 810 may inform the user about the acceptance using a voice.

The control signal processor 810 may communicate with the participant terminal device 140 over the network connection unit 840 using a control signal of a predetermined standard, for example, a communication provider standard.

When the control signal is received from the participant terminal device 140, the function controller 850 may transfer a command according to interpretation of the control signal processor 810.

The media conversion controller 820 may match a media standard supported by a communication provider network with a media standard supported by a participational broadcasting model according to the present invention.

When channel information and participation address information is managed as a pair and a participation request is received from the user, the channel association manager 830 may transfer the channel information and information associated with broadcasting participation.

Also, when a response message to the request message received from the participant terminal device 140 is received from the participation control server 120 by controlling the control signal processor 810, the function controller 850 may transmit the received response message to the participant terminal device 140, may convert the response message based on a terminal support standard, and may transmit the converted response message to the participant terminal device 140.

Also, the function controller 850 may convert, based on a participational broadcasting media standard, participation data received from the participant terminal device 140, and transmit the converted participation data to the media mixer server 110. When mixed broadcasting data in which the participation data is mixed is received from the media mixer server 110, the function controller 850 may transmit the mixed broadcasting data to the participant terminal device 140.

According to a connection request for an advance check from the broadcasting server 150, the function controller 850 may make a request for a connection to the participant terminal device 140 and may control a connection between the participant terminal device 140 and the broadcasting server 150.

Also, the function controller 850 may control the network connection unit 840, the control signal processor 810, and the like, and control a communication among the media mixer server 110, the participation control server 120, and the participant terminal device 140 so that the user may participate into the broadcasting.

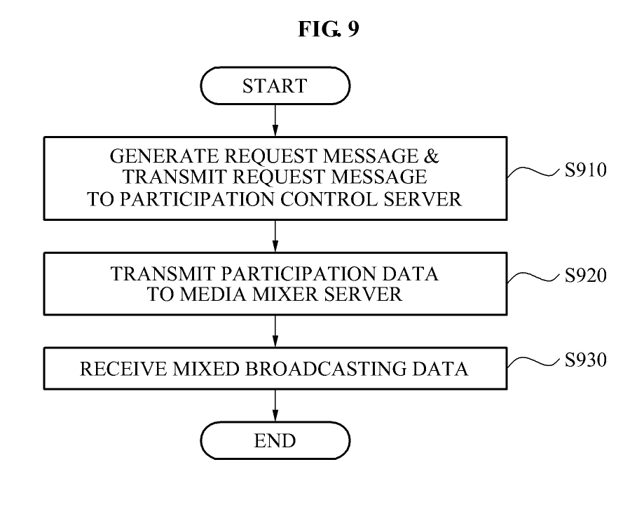

FIG. 9 is a flowchart illustrating an operation method of the participant terminal device 140 according to an embodiment of the present invention.

Referring to FIG. 9, in operation S910, the participant terminal device 140 may generate a request message according to a participation request, and may transmit the request message to the participation control server 120 identified based on participation address information.

Specifically, in a state where broadcasting data is provided to the participant terminal device 140, the participant terminal device 140 may generate the request message according to the user's participation request and transmit the request message to the participation control server 120. The participant terminal device 140 may transmit the request message to the participation control server identified based on the participation address information.

When a broadcasting environment corresponds to an IPTV network, channel information may indicate a multicast address or a port number. When the broadcasting environment corresponds to a terrestrial broadcasting network, a cable broadcasting network, a satellite broadcasting network, or a DMB broadcasting network, the channel information may indicate a frequency band.

The participation address information may correspond to information, for example, a control URI, used for the user to participate into the viewing broadcasting.

The participant terminal device 140 may transmit the request message to the participation control server 120 using internally stored predetermined participation address information or participation address information received from the participation control server 120.

The participant terminal device 140 may receive channel information from one of the auxiliary premise device 230, the set-top box 240, and the storage server 280, and may obtain, from the wired and wireless coupled server 100 or the EPG server 500 using the channel information, participation address information corresponding to the channel information.

In this instance, the participant terminal device 140 may transmit the request message to the participation control server 120 via the wired and wireless coupled server 100.

When the participant terminal device 140 receives, from the participation control server 120, a response message with respect to the request message, the participant terminal device 140 may transmit, to the media mixer server 110, participation data input by the user in operation S920.

The participant terminal device 140 may transmit the participation data to the participation control server 120 via the wired and wireless coupled server 100.

In operation S930, the participant terminal device 140 may receive, from the media mixer server 110, and thereby display mixed broadcasting data in which the participation data is mixed.

Here, the mixed broadcasting data may indicate mixed data in which broadcasting data and the participation data is mixed.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A wired and wireless coupled server for supporting broadcasting participation, comprising:
an information obtainment unit to obtain channel information associated with a broadcast provided to at least one participant terminal device among a plurality of terminal devices in response to a participation request from the at least one participant terminal device; and
an information processor to enable the at least one participant terminal device to access a participation control server associated with the broadcasting participation using participation address information corresponding to the obtained channel information by identifying the participation address information and transmitting the identified participation address information to the at least one participant terminal device.

2. The server of claim 1, further comprising:
an auxiliary premise device to cache a channel change message transmitted from a set-top box providing the broadcast to the at least one participant terminal device,
wherein the information obtainment unit obtains the channel information from the cached channel change message.

3. The server of claim 1, wherein the information obtainment unit transmits an information transmission command to a set-top box in response to the participation request, and receives the channel information from the set-top box in response to the information transmission command.

4. The server of claim 1, wherein the information obtainment unit obtains the channel information from an Electronic Program Guide (EPG) providing guidance with respect to the broadcast.

5. The server of claim 1, wherein the information obtainment unit verifies a set-top box, assigned to the at least one participant terminal device, from a management server registering set-top boxes assigned to the plurality of terminal devices, and receives the channel information from the verified set-top box.

6. A participant terminal device for supporting broadcasting participation, comprising:
a user command receiver to receive a participation request of a user for a provided broadcasting;
a broadcasting participation controller to generate a request message in response to the participation request, to transmit the request message to a participation control server identified by participation address information, and to receive a response message from the participation control server; and
a media processor to transmit, to a media mixer server using a media session established according to reception of the response message, participation data input by the user.

7. The participant terminal device of claim 6, further comprising:
an image capturing device to receive, from the user, image data included in the participation data; and
an image output unit to receive, from the media mixer server, mixed broadcasting data in which the image data is mixed, and to output the mixed broadcasting data.

8. The participant terminal device of claim 6, further comprising:
a sound capturing device to receive, from the user, sound data included in the participation data; and
a sound output unit to receive, from the media mixer server, mixed broadcasting data in which the sound data is mixed, and to output the mixed broadcasting data.

9. The participant terminal device of claim 6, wherein the participation address information is predefined for identification by the participation control server and thereby is internally stored, or is received from a wired and wireless coupled server associated with the broadcast.

10. A wired and wireless coupled server for supporting broadcasting participation, comprising:
a media conversion controller to adjust, based on a media standard, participation address information for participation into a broadcast provided to a participant terminal device, and to control a media mixer server to match the participation address information with broadcasting data; and
a channel association manager to provide the matched broadcasting data to the participant terminal device, and to provide an interface for an input of participation data to the participant terminal device when the participant terminal device requests a participation using the participation address information.

11. The server of claim 10, wherein the participation address information comprises information provided in an alphanumeric form to access a participation control server associated with the broadcasting participation.

12. A method of providing a participational broadcasting service, comprising:
obtaining channel information associated with a broadcast provided to at least one participant terminal device among a plurality of terminal devices in response to a participation request from the at least one participant terminal device; and
identifying participation address information corresponding to the obtained channel information for accessing a participation control server associated with broadcasting participation to thereby transmit the identified participation address information to the at least one participant terminal device.

13. The method of claim 12, further comprising:
caching a channel change message transmitted from a set-top box providing the broadcast to the at least one participant terminal device,
wherein the obtaining comprises obtaining the channel information from the cached channel change message.

14. The method of claim 12, wherein the obtaining comprises:
transmitting an information transmission command to a set-top box in response to the participation request; and
receiving the channel information from the set-top box in response to the information transmission command.

15. The method of claim 12, wherein the obtaining comprises the channel information from an EPG providing guidance with respect to the broadcast.

16. The method of claim 12, wherein the obtaining comprises:
verifying a set-top box, assigned to the at least one participant terminal device, from a management server registering set-top boxes assigned to the plurality of terminal devices; and
receiving the channel information from the verified set-top box.

17. A method of providing a participational broadcasting service, comprising:
receiving a participation request of a user for a provided broadcast;
generating a request message in response to the participation request to transmit the request message to a participation control server identified by participation address information, and to receive a response message from the participation control server; and
transmitting, to a media mixer server using a media session established according to reception of the response message, participation data input by the user.

18. A method of providing a participational broadcasting service, comprising:
adjusting, based on a media standard, participation address information for participation into a broadcast provided to a participant terminal device;
providing, to the participant terminal device, broadcasting data matched with the participation address information; and
providing an interface for an input of participation data to the participant terminal device when the participant terminal device requests to participate using the participation address information.
